(19) United States
(12) Patent Application Publication
(10) Pub. No.: US 2007/0262988 A1
(43) Pub. Date: Nov. 15, 2007

(54) METHOD AND APPARATUS FOR USING VOXEL MIP MAPS AND BRICK MAPS AS GEOMETRIC PRIMITIVES IN IMAGE RENDERING PROCESS

(75) Inventor: Per Christensen, Edmonds, WA (US)

Correspondence Address: TOWNSEND AND TOWNSEND AND CREW, LLP/PIXAR, TWO EMBARCADERO CENTER, EIGHTH FLOOR, SAN FRANCISCO, CA, 94111-3834, US

(73) Assignee: Pixar Animation Studios, Emeryville, CA (US)

(21) Appl. No.: 11/743,549

(22) Filed: May 2, 2007

Related U.S. Application Data
(60) Provisional application No. 60/799,134, filed on May 9, 2006.

(51) Int. Cl. G06T 17/00

(52) U.S. Cl. 345/424

(57) ABSTRACT

A system, apparatus and method of rendering images for computer graphics or animation at multiple levels of detail or resolution. The invention uses a hierarchical data structure and provides methods of generating and using that structure for rendering images. The invention generates a data structure containing data elements representing multiple resolutions of data and then determines a desired resolution for the image. The data elements in the data structure corresponding to the desired resolution are accessed and each data element in the accessed data is associated with a renderable primitive. The image is then rendered by processing the renderable primitive associated with each data element.

### CROSS-REFERENCE TO RELATED APPLICATIONS

This application claims the benefit of U.S. Provisional Patent Application No. 60/799,134, entitled “Method and Apparatus for Using Brick Maps as Geometry”, filed May 9, 2006, the contents of which is incorporated herein for all purposes.

### BACKGROUND

The present invention is directed to apparatus and methods used in computer graphics and animation, and more specifically, to methods of rendering images of three-dimensional objects at multiple levels of detail or resolution.

In the field of computer graphics and animation, rendering refers to the process of producing a two-dimensional picture or image of a three-dimensional object by processing three dimensional data corresponding to that object. The data corresponding to the object may be obtained by scanning or sampling a physical object, or the data may be generated by a mathematical model of the geometry of an object. To produce the rendered image, the data is typically processed by a software program that determines or approximates the light seen from each point on the surface of the object (or from its interior if the surface or part of it is transparent) and how that light is affected by transport through a viewing medium. The rendering process may be modified to take into account that the object is being viewed from a specified perspective in a specified environment. Thus, a full set of data used for rendering may include data related to the geometric characteristics of the object, its surface or volume characteristics (texture, opacity, etc.), ambient lighting and viewing perspective.

The amount of data required for rendering an image depends to some extent upon the degree of detail or resolution desired in the final rendered image. Further, the computational resources and time required to render an image from the data depends upon the amount of data being processed by the rendering program. As a result, using a data set corresponding to a highly detailed sampling or representation of an object may be an inefficient use of resources, and in some cases unnecessary if the final rendered image is only intended to cover a small number of pixels. In this sense, data storage and processing resources are most efficiently utilized when the amount of data being processed and the resolution of the data are closely related to the level of detail or resolution required for the rendered image. As an example, it is inefficient and an unnecessary use of data processing resources to process highly detailed data of an object to render an image that only covers a small number of pixels. In such a case, the data has much higher resolution than the final image, and the use of relatively high resolution data introduces data processing and storage inefficiencies that would be desirable to avoid.

However, for many situations during the production of a scene or film, a single sampling or representation of an object may not be sufficient. This is because multiple levels of detail may be required in order to render an image of the object that is suitable for different scenes, perspectives, etc. This means that multiple data sets may be required for a single object, with each set corresponding to a different resolution or degree of detail. The multiple data sets require multiple scans or samples of a real object, or the generation of multiple sets of data representing the object, with each set corresponding to a different level of detail or resolution. This requirement can present a problem during production as there may not be sufficient time or resources available to produce the data. Although it is possible to generate only a single high resolution data set and use that as the basis for all desired image resolutions, this is not optimal as it introduces inefficiencies in computing and data storage resource usage.

As noted, in the field of computer animation, data representing an object may be obtained by several methods. If an actual, physical object is serving as a source of data, then a laser range-finder may be used to scan the object and provide three dimensional data representing the object. The collected data is typically in the form of a point cloud (an unorganized set of data points), where each point includes a position, and may also include a radius, surface normal, color data, etc. Object data may also be generated by executing a mathematical model that is a construction of the geometry of the object. In such a situation, object surfaces may be represented as polygon meshes, NURBS patches (a type of parametrically defined surface patch), subdivision surfaces, or a similar construct. Typically, the surface of the object is sub-divided into pixel sized micro-polygons, with each such micro-polygon being used to generate a data point. This is a problem if an object with a very complex surface representation is only covering a few pixels in the final image because a rendering program will spend an excessive amount of computational resources rendering the object, i.e., more than is necessary for presentation in the final image.

To address this problem, some rendering programs allow the definition of multiple levels of detail (LODs) or resolutions for an object. In such a case, the rendering program will select the appropriate level of detail, or interpolate between two levels of detail when generating the image. Although this approach works well in reducing the computations required by the rendering program, it has the disadvantage of requiring that several representations of the same object be explicitly generated. The generation of those representations must typically be done a priori, by a separate software program. Thus, in order to generate the desired degree of detail for a particular group of scenes, it may be necessary to have previously generated a group of data sets, with each set corresponding to a different degree of detail, followed by rendering the desired set as needed for the scene. This increases the data collection or generation requirements, as a program may be needed to separately generate multiple representations of an object or require that an actual object be sampled at multiple resolutions. It may also increase data storage requirements and complicate other aspects of the process of generating multiple level of detail representations of an object.

Data for generating animated scenes may be stored in different types of data structures. One such structure is a voxel MIP map, where a voxel is a unit or element of data corresponding to a volume in space and may contain data or be empty. A voxel MIP map is typically constructed as an octree of voxels, where each voxel has (up to) eight children. The data in each voxel is the average of the data in its children. This form of structure is related to that described in the paper entitled “Pyramidal Parametrics”, by Lance Williams, Computer Graphics, July, 1983.

Another form of data structure that may be used for data storage is termed a “brick map”, which is a form of voxel MIP map. In a brick map, the voxels are organized into cubic groups of N×N×N voxels. Each group is termed a “brick”, hence the term brick map. A brick map may be used in computer graphics to store data representing the texture of an object's surface or characteristics of its volume. As with voxel MIP maps, a brick map is typically represented as an octree, a tree where each node has eight “children”. Each node of an octree may be represented as a cube in space, with each “child” being one octant of its “parent”. A brick map is an octree with a brick at each node, where each brick consists of a cube of N×N×N voxels. Thus, in a brick map, each brick at a given level may have up to eight bricks associated with it at the next lower level, and so on. Viewed this way, at the top level is a single brick with eight bricks at the next level associated with that brick. For each of those eight bricks, there are associated another eight bricks at the next lower level, and so on with each succeeding level.

An advantage of using a brick map representation over a voxel MIP map is that nearby voxels are stored together in memory and cache. If the voxels and their data are accessed in a coherent way (which is typically the case), then the brick map representation provides higher memory access coherency, easier caching, and higher cache hit rates.

Although present methods of rendering an object at multiple levels of detail or resolution do provide a means of performing that task, they have disadvantages with regards to data collection or generation, data storage requirements, computational complexity, and ease of use. What is desired is an apparatus and associated method of rendering an image with a desired resolution or level of detail that overcomes the disadvantages of current approaches.

### BRIEF SUMMARY

The present invention is primarily directed to systems, apparatus and methods of rendering images for computer graphics or animation at multiple levels of detail or resolution. The invention is computationally efficient and adapted for use in the production of animated scenes or features. In some embodiments, the invention includes using an adaptive brick map data structure and associated methods of generating data for, and using that structure in the rendering of images. The brick map contains a hierarchical arrangement of data, with each level or region of data in the hierarchy representing a different resolution of the data obtained from sampling the object to be rendered, or data generated based on a mathematical model of the geometry of the object. In some embodiments, the sampled or generated data is used for the highest resolution images, with lower resolution images being produced from data generated from the highest resolution data and stored in the brick map. In contrast to other methods of rendering an image, the brick map is used as a geometric primitive, meaning that the data stored in the brick map is operated on directly during the rendering process. This is accomplished by associating each element of the stored data with a renderable primitive and then processing those primitives to produce the desired image. Further, in some embodiments, the renderable primitive and associated data elements may be processed to produce the image.

In some embodiments of the invention, the object to be rendered as an image is sampled in three dimensions or data representing the object is generated using a mathematical model of the geometry of the object. The sampling or data generation is performed to yield the highest resolution data expected to be used in the rendering process to produce the desired image or scene. The sampled or generated data is stored in a hierarchical arrangement within a data structure, where each level of the hierarchy contains data of progressively higher resolution or detail, with the highest being the originally sampled or generated data. Further, in some embodiments, the levels of data corresponding to lower resolution than the originally sampled or generated data are generated automatically from the original data by an averaging, smoothing, or other suitable process.

In the rendering process, the data structure may be accessed and the desired level of detail or resolution for the final image used to determine the appropriate level of the hierarchical data structure to process to yield the final image. When a different level of detail or resolution is desired, the same data structure may be accessed and the appropriate level of data operated upon to yield the newly rendered image, without the need to generate a new data representation of the original object. Thus, in some embodiments, only one set of data need be collected or generated in order to provide the ability to generate multiple levels of detail or resolution as needed for an image or scene. Further, in some embodiments, computational resources and time are used more efficiently because only the data corresponding to the desired level of detail or resolution of the final image or scene is accessed and associated with a renderable primitive as part of the rendering process.

In some embodiments, the present invention is directed to a computer implemented method of rendering an image at a desired resolution that includes generating a data structure containing data elements representing multiple resolutions of data, determining a desired resolution for the image, accessing the data elements in the data structure corresponding to the desired resolution, associating each data element in the accessed data with a renderable primitive, and rendering the image by processing the renderable primitives associated with each data element.

In another embodiment, the present invention is directed to a system for rendering images, where the system includes a processor configured to execute a sequence of instructions, a data storage medium configured to store the sequence of instructions, and a second data storage medium, where the second medium is configured to hierarchically store a plurality of data sets, with each data set corresponding to a different resolution of data, and when executed by the processor, the sequence of instructions implements a process to determine which one or ones of the plurality of data sets contain data corresponding to a desired resolution for a rendered image, access the one or ones of the plurality of data sets that contain data corresponding to the desired resolution, associate each data element in the accessed data sets with a renderable primitive, and render the image by processing the renderable primitives associated with each data element.

Other objects and advantages of the present invention will be apparent to one of ordinary skill in the art upon review of the detailed description of the present invention and accompanying figures.

### BRIEF DESCRIPTION OF THE DRAWINGS

FIG. 1 is a flowchart illustrating an exemplary process for generating a multi-resolution data structure for use in rendering an image in accordance with some embodiments of the present invention;

FIG. 2 is a flowchart illustrating a process for rendering an image at a desired level of detail or resolution in accordance with some embodiments of the present invention;

FIG. 3 is a block diagram of a typical computer system that may be used to implement some embodiments of the present invention;

FIG. 4 is a diagram illustrating a perspective view of a first level of a hierarchical data structure (termed a brick map) that may be used as part of a rendering process in accordance with some embodiments of the present invention;

FIG. 5 is a diagram illustrating a perspective view of a second level of a hierarchical data structure (termed a brick map) that may be used as part of a rendering process in accordance with some embodiments of the present invention; and

FIG. 6 is a diagram illustrating a perspective view of a third level of a hierarchical data structure (termed a brick map) that may be used as part of a rendering process in accordance with some embodiments of the present invention.

### DETAILED DESCRIPTION

The present invention is directed to systems, apparatus, and methods for generating images at multiple levels of detail or resolution for use in computer graphics or animation productions. As part of the image rendering process, the invention utilizes a hierarchical data structure that contains multiple levels of detail or resolution of object data, with the highest resolution data representing the object obtained by sampling a physical object or generating data from a model of an object. In some embodiments, the highest resolution data is processed to yield lower resolution data using a smoothing, averaging, or other suitable process, with the new data being stored in a separate level of the data structure. This process is repeated to produce sets of data at even lower resolutions by processing the data set obtained by processing the high resolution data, and so on. When generating an image for a scene, the level of detail or resolution required for the scene is determined, followed by accessing the level or levels of the data structure corresponding to that level of detail or resolution. The data elements or voxels contained in the accessed level are then associated with a “renderable primitive”, so that each data element or voxel has a corresponding primitive. The primitive may be a cube, sphere, disc, or other suitable element. The renderable primitive is then processed or rendered to yield the desired image. In some embodiments, the data contained in the voxel or data element may also be used as part of the rendering process.

Although the present invention will be described with reference to example embodiments, it is noted that practice of the invention is not limited to those embodiments. For example, the hierarchical data structure need not be the described voxel MIP map, brick map or an octree structure. Similarly, the number of voxels in a unit of the structure need not be the same as for the described embodiment or embodiments of the invention. Further, the renderable primitive associated with the voxel data or other data element need not be restricted to the forms or formats mentioned, but may be generalized to any suitable form. In addition, although certain elements of the inventive system may reside in a server or servers, or connected by means of a network or networks, such elements may be separate from one another, or combined, and connected as desired to implement the functions and processes of the invention.

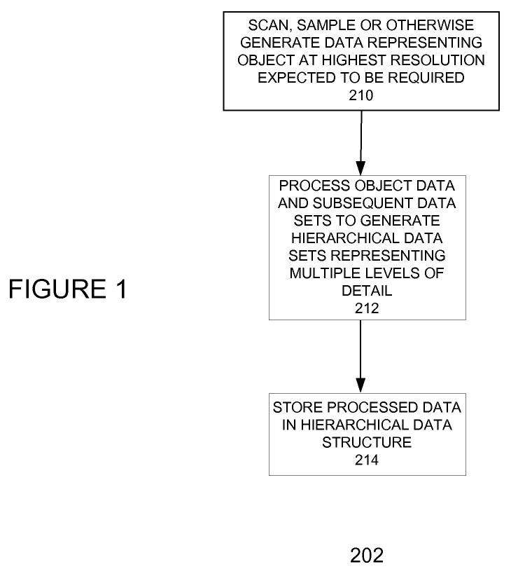

FIG. 1 is a flowchart illustrating an exemplary process 202 for generating a multi-resolution data structure for use in rendering an image in accordance with some embodiments of the present invention. As shown in the figure, process 202 typically begins with obtaining or generating data at a single resolution, where that resolution corresponds to the highest resolution expected to be used in the production process (stage 210). The data may be obtained by scanning or sampling an actual object, or generated by executing a mathematical model of the geometry of the object. Next, the data obtained or generated at high resolution is processed to generate a first processed hierarchical data set at a lower resolution than the data obtained at stage 210. This is followed by processing that first processed data set to yield data at a lower resolution than that of the first processed data set. This process is continued as needed to generate data sets representing multiple levels of detail or resolution (stage 212). Each processing stage may be done by an averaging or smoothing process, or other suitable technique. In this manner, the initially obtained or generated data is processed to yield a data set at the next level of resolution (which is lower than the processed data), with that data then processed to yield the next level of resolution, etc. The data for the multiple levels of resolution is stored in a hierarchical data structure (stage 214).

As will be discussed in greater detail, in some embodiments of the invention, the hierarchical data structure is a brick map, which in some embodiments is an octree having a single brick of N×N×N voxels at its uppermost level, eight bricks associated with that single brick at the next lower level, eight bricks associated with each of those eight at the next lower level, and so on. In other embodiments, a brick map may be represented by a single brick at its uppermost level, four bricks associated with that single brick at the next lower level, four bricks associated with each of those four bricks at the next lower level, and so on, or any other suitable configuration. In still other embodiments, the data structure may be a voxel MIP map or similar structure.

Further, in some embodiments, the data structure may contain data sampled or otherwise generated at multiple resolutions, instead of the described process of iteratively generating multiple data sets of progressively lower resolution by operating on an initial collected or generated data set. Thus, the inventive process may automatically generate data corresponding to multiple levels of detail or resolution from an initial set of data, or utilize multiple data capture or data generation events to populate the data structure.

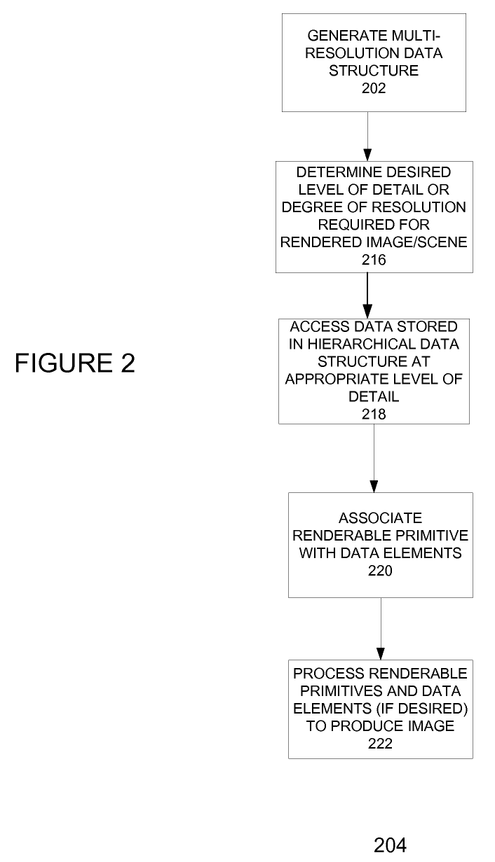

FIG. 2 is a flowchart illustrating a process 204 for rendering an image at a desired level of detail or resolution in accordance with some embodiments of the present invention. As described with reference to FIG. 1, an initial stage or step in the process is to generate a multi-resolution data structure (stage 202), i.e., a hierarchical data structure containing data elements or voxels representing multiple resolutions of data. At the next stage of the process, the desired or required degree of resolution or level of detail for the rendered image is determined (stage 216). This is typically done by determining the size (in terms of number of pixels) that the final image will have in the scene and then deriving the corresponding resolution. After determining the desired or required resolution or level of detail, the process accesses the data stored in the hierarchical data structure that corresponds to that resolution or that may be processed to yield data at that resolution (stage 218). This will typically be data stored at one of the hierarchical levels (i.e., one level or node of the octree), although it may also be obtained by averaging or interpolating the data stored at two levels.

Next, each data element (e.g., voxel or other suitable element) in the accessed data is associated with a renderable primitive (stage 220). In the context of the present invention, a renderable primitive is a box, sphere, disc, or other shape that may be processed by the data processing operations of a rendering program. In this stage or step of the inventive process, each data element is represented by a renderable primitive, and that primitive is used as the unit of data to be processed for some or all of the data processing operations that are part of the rendering process. At the next stage (222), the renderable primitive corresponding to the accessed or interpolated data is rendered to produce the final image. As will be described, the data element may also be accessed and processed as part of the rendering process.

As mentioned, at stage or step 220, the data element, voxel, or other suitable element is represented by a renderable primitive. Each renderable primitive (e.g., cube, sphere, disc, etc.) corresponding to a voxel or data element may be said in some sense to “inherit” the information contained in the data stored in the voxel. For example, if the voxel contains color data, then the renderable primitive will be characterized by that color. Similarly, if the voxel contains position and/or surface normal data, the renderable primitive will be characterized by a position and/or orientation corresponding to that position/normal. If the voxel does not contain or specify certain data (e.g., color, position/normal data) then default values may be used for that aspect of the renderable primitive.

With regards to stage or step 222, note that although the renderable primitive is processed or otherwise operated on during the rendering process, in some situations the actual voxel or data element may also be processed as part of producing the image. For example, the visibility of an object may be determined using the renderable primitives, while certain other characteristics of the object may be determined by rendering of the voxel data, such as by operating on the voxel data using a “shader” application to determine a color or opacity of the object.

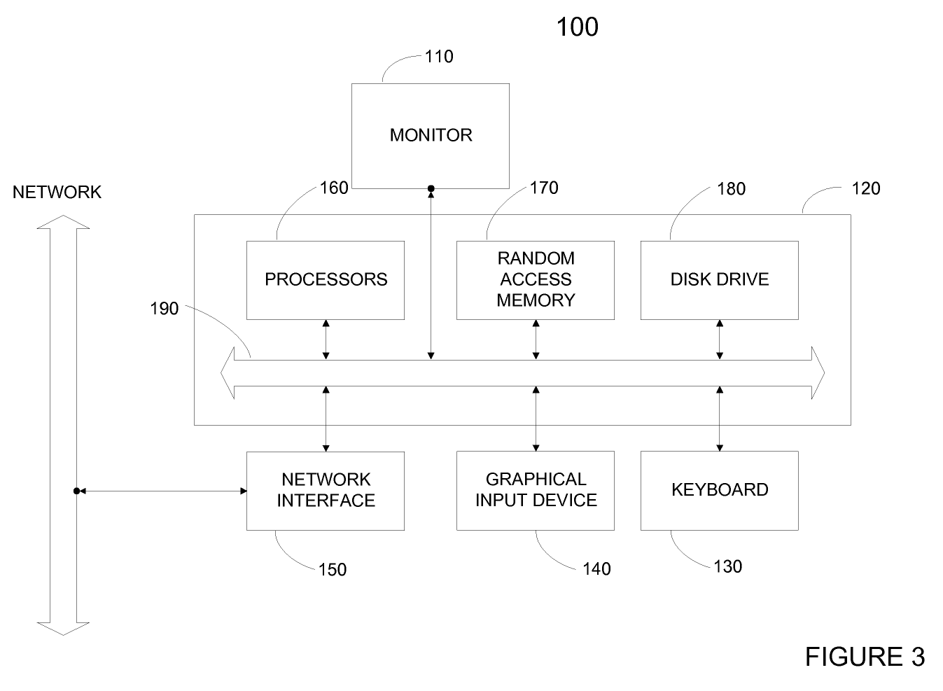

FIG. 3 is a block diagram of a typical computer system 100 that may be used to implement some embodiments of the present invention. In the present embodiment, computer system 100 typically includes a monitor 110, computer or other data processing device 120, a keyboard 130, a user input device 140, computer interfaces 150, and the like.

In one embodiment, user input device 140 is typically embodied as a computer mouse, a trackball, a track pad, a joystick, wireless remote, drawing tablet, voice command system, eye tracking system, and the like. User input device 140 typically allows a user to select objects, icons, text and the like that appear on the monitor 110 via a command such as a click of a button or the like.

Embodiments of computer interfaces 150 typically include an Ethernet card, a modem (telephone, satellite, cable, ISDN), (asynchronous) digital subscriber line (DSL) unit, FireWire interface, USB interface, and the like. For example, computer interfaces 150 may be coupled to a computer network, to a FireWire bus, or the like. In other embodiments, computer interfaces 150 may be physically integrated on the motherboard of computer 120, may be a software program, such as soft DSL, or the like.

In various embodiments, computer 120 typically includes familiar computer components such as a processor 160, and memory storage devices, such as a random access memory (RAM) 170, disk drives 180, and system bus 190 interconnecting the above components. In one embodiment, computer 120 includes one or more Xeon microprocessors from Intel. Further, in one embodiment, computer 120 typically includes a UNIX-based operating system.

RAM 170 and disk drive 180 are examples of tangible media configured to store data such as an animation environment, models including geometrical descriptions of objects, descriptions of illumination sources, procedural descriptions of models, frames of training data, a specification of key points, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In some embodiments, computer system 100 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 3 is representative of a computer system 100 capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board (e.g. graphics processor unit).

As noted, in some embodiments of the invention, the hierarchical data structure is a brick map, which is an octree structure. In some embodiments, each brick in the brick map is a “cube” containing 8×8×8 voxels. Thus, at the highest level (which may be referred to as level zero), the data structure has one brick. At the next highest level (which may be referred to as level 1), the data structure has eight bricks, with each brick containing 8×8×8 voxels. At the next highest level (which may be referred to as level 2), the data structure has sixty-four bricks, again with each brick containing 8×8×8 voxels, and so on.

The number of levels or depth of the octree is determined by the density of the input data (that is the highest resolution data to be stored in the data structure). In general, it is desirable to choose the finest resolution of the octree such that the voxel or data element size is roughly the same as the radius of the data points (on average one data point per non-empty voxel). At that octree resolution, the voxel representation provides a reasonable approximation of the original point data. If the finest octree resolution was chosen to be coarser, it would not provide a good approximation of the original point data. If the finest octree resolution was chosen to be finer, then the octree memory would increase without providing any significant additional accuracy in the representation.

Note that in some embodiments, the data values for a voxel are computed as a weighted average of the data values of those original data points that overlap the voxel. For rendering, typically the level of the octree will be chosen such that a voxel is roughly the size of a pixel. Each rendered voxel may contain data from just a single data point (if the finest octree level is chosen) or it may contain average data from many data points (if a coarser octree level is chosen). Thus, from the amount of data collected or generated (which may depend on the highest resolution image expected to be required), one can determine how many bricks will be used to store the data. Given this information, the total number of levels of the octree can be determined by averaging data in the bricks at each level into the next level up (and therefore at lower resolution) until reaching the top level at which there is only a single brick.

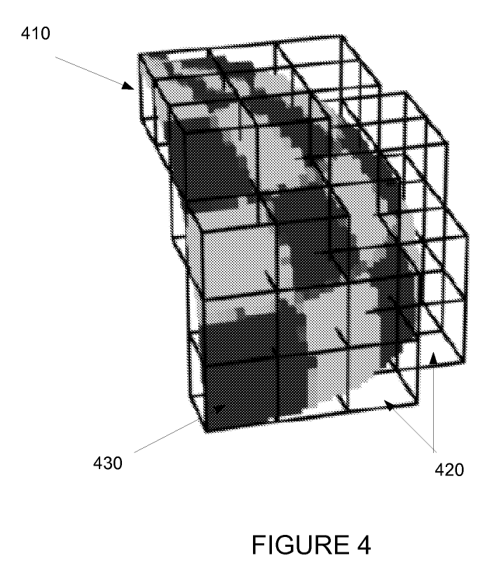

Prior to describing the process of generating and using the brick maps in greater detail, it may be instructive to illustrate the octree hierarchical data structure that is used in some embodiments of the rendering process of the present invention. FIG. 4 is a diagram illustrating a perspective view of a first level 410 of a hierarchical data structure (termed a brick map) that may be used as part of a rendering process in accordance with some embodiments of the present invention. The diagram represents a single level of the data structure, with the level corresponding to the highest resolution or level of detail of the data. The structure depicted in the figure contains sixty-four bricks 420 (in a 4×4×4 cube) with each brick containing 8×8×8 voxels. Note that some voxels or even entire bricks may contain no data and are not outlined in the figure.

The data 430 represented by the voxels in the bricks of FIG. 4 would, in some embodiments, represent the actual data obtained by scanning a physical object or generated by executing a mathematical model of the object. Further, the data represented by the voxels in FIG. 4 would typically be the highest resolution data required for the rendering process, that is the highest level of detail or resolution needed to render the object for scenes in the production.

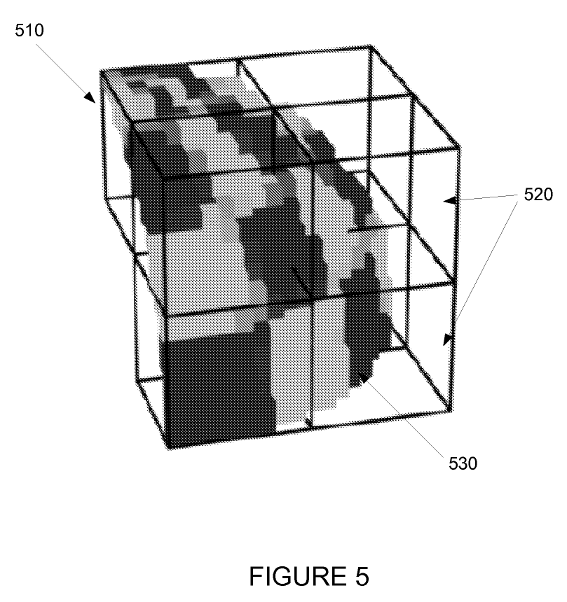

In some embodiments, the inventive process operates on the data represented by the voxels in FIG. 4 to automatically generate the data needed for the next higher level of the data structure, which would be data at lower resolution than that shown in FIG. 4. This level contains eight bricks, each again containing 8×8×8 (or 512) voxels. FIG. 5 is a diagram illustrating a perspective view of a second level 510 of a hierarchical data structure (termed a brick map) that may be used as part of a rendering process in accordance with some embodiments of the present invention. The level depicted in FIG. 5 is based on the data in the next lower level (FIG. 4) and contains data 530 at a lower resolution or level of detail than the data from which it is derived. As suggested by the voxels in FIG. 5, the resolution of the data has decreased when compared to that of FIG. 4, since each of the eight bricks 520 (in a 2×2×2 cube) in FIG. 5 now contains the same number of voxels as were present in eight bricks in the structure of FIG. 4.

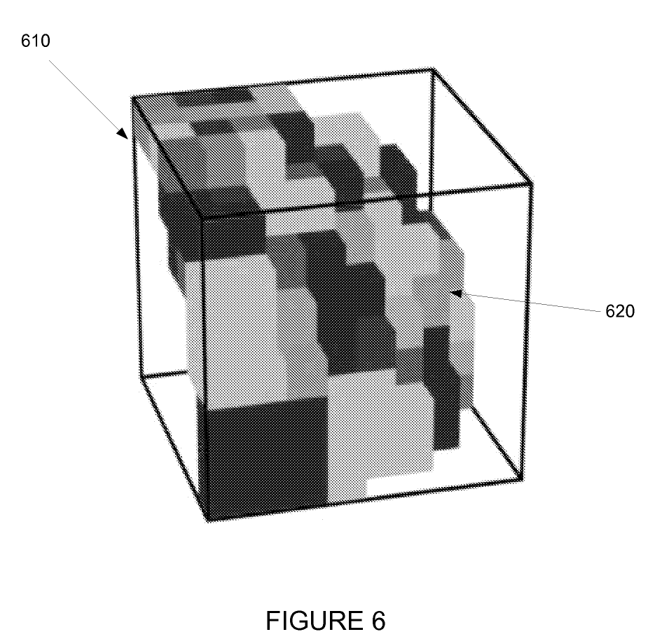

The averaging, smoothing, or other suitable process is again applied to the data contained in the bricks and voxels of FIG. 5 to generate the data for the next level up of the data structure. In some embodiments, the data could be, for example, average position, normal, color, transparency, specularity, density, texture parameters, surface parametric values (u,v) or (s,t), volume scattering coefficients, etc. This next level contains one brick, again with 8×8×8 voxels. FIG. 6 is a diagram illustrating a perspective view of a third level 610 (containing a single brick) of a hierarchical data structure (termed a brick map) that may be used as part of a rendering process in accordance with some embodiments of the present invention. The level depicted in FIG. 6 is based on the data in the next lower level (FIG. 5) and contains data 620 at a lower resolution or level of detail than the data from which it is derived. As suggested by the voxels in FIG. 6, the resolution of the data has decreased when compared to that of FIG. 5, since the brick in FIG. 6 now contains the same number of voxels as were present in eight bricks in FIG. 5. The level depicted in FIG. 6 would be the final or uppermost level of the brick map since it contains a single brick.

The present invention has been described generally with reference to FIGS. 1-6. Further details of various embodiments and implementations of the invention will now be presented. As discussed, the data collected from an actual physical object or generated by a mathematical model may be termed a point cloud. Point clouds are typically generated as unorganized collections of data points. In order to utilize the data more efficiently (i.e., more quickly accessible and at the appropriate resolution), the inventors have introduced a brick map data structure—a tiled, adaptive octree suitable for caching in memory. The brick map representation may be used for both surface and volume data, and is independent of the parameterization of the surface.

In some embodiments, a brick contains 8×8×8 voxels where each voxel is associated with data values such as (but not limited to) average position, normal, color, transparency, specularity, density, texture parameters, surface parametric values (u,v) or (s,t), volume scattering coefficients, etc. Note that the invention may be implemented with a different number of voxels per brick as well. Similarly, although some embodiments of the invention utilize an octree data structure, it is not limited to that form of structure and may be used with others as well. As noted, there are two basic types of brick maps: brick maps for surface data and brick maps for volume data. Surface data points have associated normals, and to avoid mixing data from the two sides of one surface, the points can be divided into six groups depending on the dominant direction of the normal (+x, −x, +y, −y, +z, and −z). Each of the six groups may be stored in a separate octree. Volume data points do not have surface normals, so one octree is sufficient for storing that data.

One process for creating a brick map will now be described. Given a set of points with associated radii, data, and possibly normals, a brick map representation of the data will be generated for use in the inventive rendering process. This may be accomplished in three steps. First the bounding volume of the entire data set is found. Then, the data points are divided into seven groups, depending on their normals: one group for points with no normal, and one group for each of the six major directions. Data for points with normals close to 45 degrees may be assigned to 2 (or even 3) groups to facilitate faster data access.

Next, each data group is stored in a hierarchical data structure such as the brick map octree structure described previously. The octree nodes and bricks are created as the data points are inserted into the structure. Each octree node may consist of 9 pointers: eight pointers to child nodes and one pointer to a brick containing the data for the current node. For each data point p, the process computes a small volume, Vp, based on its position and radius. For each octree node, starting at the appropriate root, the data are recursively inserted into the bricks of the octree nodes that Vp overlaps. When a point's data are inserted into a brick, the process determines which brick voxels the point's volume overlaps, and adds the data values to the data in those voxels. When added, the data are multiplied by a weight (Vp∩Vv)/Vp that indicates how large a fraction of the point volume, Vp, overlaps the voxel volume, Vv. This weights the data based on the overlap between the point and voxel volumes.

When all the data have been inserted, the process of constructing the brick map proceeds to the third step. First, the data values in all voxels are divided by the weight of the voxel. The process then determines the data variation of all 2×2×2 voxel groups of the brick. If the voxel group data variation is smaller than a user-specified maximum error, then the data in those eight voxels is eliminated. If all voxel data in a brick are eliminated, that entire brick may be eliminated. If any voxel data of a brick are not eliminated by this process, the remaining voxel data of the brick are stored in memory. Empty voxels are not stored, thereby saving disk space when storing sparse brick maps. To reduce the peak memory usage during brick map construction, the process may construct and write to storage one octant of each octree at a time. Furthermore, brick voxels and voxel data may be dynamically allocated and enlarged as needed during construction. In this way, the process avoids allocating an entire set of voxels for sparse bricks.

Next, a process for determining the appropriate hierarchical level of the data structure for use in the rendering process will be described. Typically, to obtain a reasonable image quality and utilize the computational resources efficiently, it is desirable to have each pixel in the final rendered image correspond to one voxel of data. Therefore, given the desired final size of the rendered image in pixels, the number of voxels required to be processed can be determined. Given the number of voxels to be processed, the corresponding hierarchical level can be determined, since it is known how many bricks and hence how many voxels are present in each level. If the desired size of the final rendered image indicates that the number of voxels falls between two hierarchical levels, then voxels from both levels may be accessed and rendered, followed by a blending operation.

As described with reference to FIG. 2, stage 220, after accessing the data elements corresponding to the desired level of detail or resolution from the data structure, the inventive process represents or associates each data element (e.g., a voxel) with a “renderable primitive”. In the context of the present invention, a renderable primitive is a box, sphere, disc, or any other suitable shape that is capable of being rendered or otherwise processed by a rendering program or application. The shape selected for the primitive may be a function of the type of data, its complexity, or an aspect of the rendering processes to be applied to the data/primitive when generating an image. The position, orientation, color, opacity, etc. of the renderable primitive can be determined from the data stored in the voxel, or default values may be applied.

For example, if the voxel contains position data, then the renderable primitive can be centered at that position. Otherwise, the voxel center may be used as the position. If the voxel contains orientation data (e.g., a surface normal), then the renderable primitive can be oriented accordingly. Otherwise, the renderable primitive can be axis-aligned, face the viewing position or rendered using another default orientation. If the voxel contains color data, then the renderable primitive can be assigned that color. Otherwise, the renderable primitive can be assigned a default color. Similarly, if the voxel contains opacity data, then the renderable primitive can be assigned that opacity. Otherwise the renderable primitive can be assigned a default opacity. Further, the renderable primitives can optionally be processed by a “shader” program that can modify the position, normal, color, and opacity of one or more renderable primitives.

In operation, bricks may be read from a data storage disk on demand and cached in memory. If the cache lookups are coherent, the cache has a high hit rate and caching is very efficient. The cache may use a least-recently-used (LRU) replacement strategy. In one implementation, the brick map cache size can be selected by the user. The default size may be set at 10 MB, corresponding to a capacity of 1574 bricks if the brick data consist of 3 floats per voxel.

As discussed, a benefit of the invention is the ability to render the brick maps directly, and if desired, to use both the renderable primitives and the voxel or data element data as part of the rendering process. This is in contrast to rendering the scanned or model generated data, as is typically done in other rendering methods. The present invention has desirable properties since the brick map is an inherent level-of-detail representation of the geometry. Since the bricks are stored in a fixed-size cache and only loaded on demand, the user can render complex scenes in a computationally efficient manner with this approach. As an example, consider a complex object defined as a very dense polygon mesh or a large collection of NURBS patches. Even if the object only covers a single pixel in the image, one would typically need to read the entire object definition into memory (and keep it there until certain it is not needed further). In contrast, if the object is represented using the inventive brick map based method, only the very coarsest brick will be read in and stored in memory. As noted, the appropriate brick map level may be determined from the screen size of the object, where a reasonable convention is to choose the brick map level such that the brick voxels are approximately the size of an image pixel.

Note that in addition to rendering directly visible brick maps, ray tracing and other operations may also be applied to them. The appropriate brick map level may be determined from the ray differential (where the ray differential describes the difference between a ray and its—real or imaginary—“neighbor” rays). The method may select the brick map level where the brick voxels are approximately the size of the ray differential cross-section. The ray-brick intersection test can be performed in several ways. A brute-force approach would be to test for intersection with each of the (up to 512) non-empty voxels in the brick (this is the most efficient approach for bricks with very few non-empty voxels). For denser bricks it is more efficient to recursively subdivide the brick into octants and test the octants for intersection before continuing the recursion (note that the recursion stops after at most three levels when the method reaches the level of individual voxels). A voxel grid-stepping approach similar to Bresenham's line-drawing algorithm is also possible to utilize.

As noted, in addition to ray tracing, other rendering operations may be applied to the data stored in the brick map. These include displacement mapping, motion blurring, shading operations, etc. In general, the brick map may be treated as a geometric primitive and operated on as one would process other geometric primitives in a rendering process.

A system, apparatus, and method of rendering images at multiple levels of detail or resolution for computer graphics or animation has been described. The invention is more computationally efficient than current approaches and provides advantages when compared to such approaches. The invention uses a hierarchical data structure (such as the described brick map or another suitable structure) to store data at multiple levels of detail or resolution, where the invention automatically generates those multiple levels of detail or resolution from an initial set of collected or generated high resolution data. As part of the rendering process, the invention determines the appropriate hierarchical level of data to access and then associates a renderable primitive with each voxel or data element in the accessed data. The process then renders the renderable primitives to produce the desired image.

Various embodiments of the invention provide several important benefits and advantages:
the hierarchical data structure (e.g., brick map) is independent of the original surface type: it doesn't matter whether the surface is a polygon mesh, a collection of NURBS patches, a subdivision surface, or another form;
the invention does not require a 2-dimensional surface parameterization, a benefit because specifying such a parameterization for surfaces such as subdivision surfaces, implicit surfaces, and dense polygon meshes can be cumbersome;
brick maps automatically adapt to the data density and variation. If, for example, a fairly smooth 3D texture has only one small region with a lot of detail, there will be relatively more bricks in that one small region, and fewer in other regions (in contrast to traditional 2D textures where the entire texture has to have high resolution if just a small part of it has a lot of detail);
the brick map representation is suitable for efficient filtering at various scales;
bricks are well suited for caching in memory (this makes it possible to deal efficiently with large brick maps—even collections of brick maps much larger than the available memory); and
the user can specify the required accuracy when the brick map is created (this makes it simple to trade off data precision vs. file size).

It should be understood that the present invention may be implemented in the form of control logic using software, hardware, or a combination of both, in a modular or integrated manner. The present invention can be implemented as a stand-alone system or as part of a larger computer system. Based on the disclosure provided herein, a person of ordinary skill in the art will know of other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

As used herein, the use of “a”, “an” or “the” is intended to mean “at least one”, unless specifically indicated to the contrary.

What is claimed is:

1. A computer implemented method of rendering an image at a desired resolution, comprising;
generating a hierarchical data structure containing data elements representing multiple resolutions of data, wherein the hierarchical data structure is a voxel MIP map or a brick map;
determining a desired resolution for the image;
accessing the data elements in the data structure corresponding to the desired resolution;
associating each data element in the accessed data with a renderable primitive; and
rendering the image by processing the renderable primitives associated with each data element.

2. The method of claim 1, wherein rendering the image by processing the renderable primitives associated with each data element further comprises rendering the image by processing the renderable primitives and the data element associated with each renderable primitive.

3. The method of claim 2, wherein rendering the image by processing the renderable primitives and the data element associated with each renderable primitive further comprises:
determining visibility of an object by processing the renderable primitives; and
shading the object by processing the data elements.

4. The method of claim 1, wherein the renderable primitive is one of a box, sphere, or disc.

5. The method of claim 1, wherein the data elements are voxels.

6. The method of claim 1, wherein at least some of the data elements contain information about position that is used to position the renderable primitive associated with the data element.

7. The method of claim 1, wherein at least some of the data elements contain information about orientation that is used to orient the renderable primitive associated with the data element.

8. The method of claim 1, wherein at least some of the data elements contain information about color that is used to provide color information for the renderable primitive associated with the data element.

9. The method of claim 1, wherein at least some of the data elements contain information about opacity that is used to provide opacity information for the renderable primitive associated with the data element.

10. The method of claim 1, wherein generating a data structure containing data elements representing multiple resolutions of data further comprises:
accessing a set of data corresponding to a first resolution;
processing the accessed set of data at the first resolution to generate a second data set containing data corresponding to a resolution lower than the first resolution;
repeating the processing step as desired to generate one or more additional data sets, wherein each additional data set is of lower resolution than the data set from which it was generated; and
storing the generated data sets in a hierarchical data structure, wherein each of the generated data sets is stored in a separate hierarchical level of the hierarchical data structure.

11. The method of claim 10, wherein the first resolution corresponds to the highest resolution required for the rendered image in the scene.

12. A computer implemented method of rendering an image at a second resolution, where the second resolution is a lower resolution than a first resolution, comprising:
obtaining data at the first resolution;
generating data at the second resolution by processing the data at the first resolution;
storing the data at the first and second resolutions in a hierarchical data structure, wherein the hierarchical data structure is a voxel MIP map or a brick map;
accessing the data at the second resolution stored in the hierarchical data structure;
associating the accessed data with a renderable primitive; and
rendering the image by processing the renderable primitive associated with the data.

13. The method of claim 12, wherein the data at the first resolution is obtained by scanning a physical object or by executing a mathematical model of an object.

14. The method of claim 12, wherein rendering the image by processing the renderable primitive associated with the data element further comprises rendering the image by processing the renderable primitive and the data associated with the renderable primitive.

15. The method of claim 14, wherein rendering the image by processing the renderable primitive and the data associated with the renderable primitive further comprises:
determining visibility of an object by processing the renderable primitive; and
shading the object by processing the data.

16. The method of claim 12, wherein the renderable primitive is one of a box, sphere, or disc.

17. A system for rendering images, comprising
a processor configured to execute a sequence of instructions;
a data storage medium configured to store the sequence of instructions,
a second data storage medium, wherein the second medium is configured to hierarchically store a plurality of data sets, with each data set corresponding to a different resolution of data, and further, wherein the second storage medium is a voxel MIP map or a brick map;
wherein when executed by the processor, the sequence of instructions implements a process to:
determine which one or ones of the plurality of data sets contain data corresponding to a desired resolution for a rendered image;
access the one or ones of the plurality of data sets that contain data corresponding to the desired resolution;
associate each data element in the accessed data sets with a renderable primitive; and
render the image by processing the renderable primitives associated with each data element.

18. The system of claim 17, wherein rendering the image by processing the renderable primitives associated with each data element further comprises rendering the image by processing the renderable primitives and the data elements associated with the renderable primitives.

19. The system of claim 18, wherein rendering the image by processing the renderable primitives and the data elements associated with the renderable primitives further comprises:
determining visibility of an object by processing one or more renderable primitives; and
shading the object by processing one or more data elements.

20. The method of claim 17, wherein the renderable primitive is one of a box, sphere, or disc.

21. A computer readable medium containing computer executable instructions, which when executed by a computing device or processor implement a process, the process comprising:
generating a data structure containing data elements representing multiple resolutions of data;
determining a desired resolution for an image;
accessing the data elements in the data structure corresponding to the desired resolution;
associating each data element in the accessed data with a renderable primitive; and
rendering the image by processing the renderable primitives associated with each data element.
